(19) United States
(12) Patent Application Publication
(10) Pub. No.: US 2012/0128011 A1
(43) Pub. Date: May 24, 2012

(54) METHOD ON A NETWORK ELEMENT FOR THE PURPOSE OF SYNCHRONIZATION OF CLOCKS IN A NETWORK

(76) Inventors: Øyvind Holmeide, Oslo (NO); Pål-Jørgen Kyllesø, Oslo (NO)

(21) Appl. No.: 13/376,676

(22) PCT Filed: May 18, 2010
(86) PCT No.: PCT/NO10/00182

§ 371 Date: Jan. 25, 2012

(30) Foreign Application Priority Data
Jun. 16, 2009 (NO) 2009 2318

(51) Int. Cl. H04J 3/06

(52) U.S. Cl. 370/474

(57) ABSTRACT

It is described a method on a network element with one or more communication ports for transmitting and receiving data packets to and from other network elements in a network for the purpose of synchronization of clocks in a network, said network element comprising a time synchronization module, a time synchronization module clock and a database.

### TECHNICAL FIELD

The present invention relates to a method on a network element with one or more communication ports for transmitting and receiving data packets to and from other network elements in a network for the purpose of synchronization of clocks in a network.

### BACKGROUND

Time synchronization in a network based on IEEE1588 or NTP/SNTP is based on time stamping of incoming and outgoing time packets on the time server (time source) and the time clients. Accurate time synchronization can be achieved if the time stamping is performed close to the physical layer of the network element. Measurement of—and correction for packet delay of the time packets through network elements such as switches and routers on the network paths between the time server and the clients have also impact on time synchronization accuracy. IEEE1588, Std 2002 and Std 2008, defines time servers as Master Clocks (MC), network elements such as switches and routers with support for measurement of—and correction for packet delay of time packets for Boundary Clocks (BC) or Transparent Clocks (TC) and time clients as Slave Clocks (SC).

A Transparent Clock as described in IEEE1588 Std 2008 represents better accuracy than a corresponding Boundary Clock implementation; see IEEE1588 Std 2002 and IEEE1588 Std 2008. This degradation of accuracy relates to a higher number of control loops for networks with Boundary Clocks compared to networks with Transparent Clocks. The number of control loops between a PTP grand master and a given PTP slave will be equal to the number of network hops between the PTP grand master and the PTP slave, while there will be only one control loop in case the network elements, e.g. switches and routers, between the PTP grand master and the slave have Transparent Clock support.

A Boundary Clock with N ports is connected to N different clock domains. PTP time packets are not sent from one port to another on the Boundary Clock, while this is the principle for a Transparent Clock. A Transparent Clock with N ports is only connected to one clock domain.

Forwarding of time packets from one port to another port can be a problem in case the Transparent Clock is a router or in case packet encryption is used. A Boundary Clock implementation can be a better choice in networks with such requirements.

U.S. Pat. No. 7,263,626 describe a method where time stamps are inserted on-the-fly into time synchronization packets in—or close to a physical layer on a network element. Time stamps are inserted into time packets that are received on the network element, and into time packets which are sent from the network element. The solution described in this document defines a method where time stamps are generated in—or close to the physical layer of the network element and where these time stamps are temporarily stored in a common data base of the time synchronization module in order to remove or reduce the interaction with a CPU for the purpose of insertion of time stamps in time synchronization packets. Time synchronization packets are generated in the time synchronization module.

### SUMMARY OF THE INVENTION

The present invention has been conceived to alleviate some of the problems above and provide an alternative implementation of a transparent clock.

In a first aspect the invention provides a method on a network element with one or more communication ports for transmitting and receiving data packets to and from other network elements in a network for the purpose of synchronization of clocks in a network, said network element comprising a time synchronization module, a time synchronization module clock and a database, said method comprising the following steps:
(1-a) receiving a time synchronization packet or a time synchronization command on a port of the time synchronization module of the network element, and
(1-b) if a time synchronization packet is received on an ingress controller of the time synchronization module, to perform the following steps:
   (1-b1) generate an ingress time stamp based on the time synchronization module clock,
   (1-b2) create a new entry in the data base of the time synchronization module and add the ingress time stamp and at least one data base entry identifier into the new data base entry, and
   (1-b3) generate a time synchronization command including at least one data base entry identifier, or
(1-c) if a time synchronization command is received on an egress controller of the time synchronization module, to perform the following steps:
   (1-c1) generate a time synchronization packet according to the time synchronization command,
   (1-c2) extract at least one data base entry identifier from the time synchronization command for data base look-up, and
   (1-c3) search for a data base entry match, wherein the entry contains an ingress time stamp, an egress time stamp or a residence time or a combination of these.

In an embodiment step (1-c3) may be followed by the steps of:
if a data base entry match with an ingress time stamp is found, to:
(2-d1) generate an egress time stamp based on the time synchronization module clock,
(2-d2) read-out the ingress time stamp from the data base entry,
(2-d3) calculate the residence time, and
(2-d4) update a time information of the time synchronization packet with the calculated residence time.

In a further embodiment step (1-c3) may be followed by the steps of:
if a data base entry match with an ingress time stamp is found, to:
(3-e1) generate an egress time stamp based on the time synchronization module clock,
(3-e2) read-out the ingress time stamp from the data base entry,
(3-e3) calculate the residence time, and
(3-e4) update the data base with the calculated residence time and the egress port.

In an even further embodiment step (1-c3) may be followed by the step of:
if a data base entry match with a residence time and an egress port is found and the egress port of the data base entry is the same as the egress port where the time synchronization command is received, to:
(4-f1) read-out the residence time from the data base, and
(4-f2) update a time information of the time synchronization packet with the residence time.

In an even further embodiment step (1-c3) may followed by the step of:
if a data base entry match with an ingress time stamp is found, to:
(5-g1) read-out the ingress time stamp from the data base, and
(5-g2) include the ingress time stamp in the time synchronization packet.

In an even further embodiment step (1-c3) may be followed by the step of:
(6-h1) generate an egress time stamp based on the time synchronization module clock, and
   if a data base entry match with an ingress time stamp is found, to:
(6-h2) read-out the ingress time stamp from the data base, and
(6-h3) include the egress time stamp and the ingress time stamp in the time synchronization packet.

In an even further embodiment step (1-c3) may followed by the step of:
if a data base entry match with an egress time stamp is found, to:
(7-i1) read-out the egress time stamp from the data base, and
(7-i2) include the egress time stamp in the time synchronization packet.

In an even further embodiment of the invention the steps above (2-d4, 3-e4, 4-f2, 5-g2, 6-h3 or 7-i2) may be followed by the steps of:
(8) sending the time synchronization packet on an egress port.

In an even further embodiment of the invention the steps above (2-d4, 3-e4, 4-f2, 5-g2, 6-h3 or 7-i2) may be followed by the steps of:
(9-j1) reading-out and include at least one general parameter from the data base into the time synchronization packet, and
(9-j2) send the time synchronization packet on an egress port.

In an even further embodiment step (1-b2) may followed by the step of:
(10) adding at least one packet parameter from the time synchronization packet into the new data base entry.

In an even further embodiment of the invention the steps above (2-d4, 3-e-4, 4-f2, 5-g2 or 6-h3) may be followed by the steps of:
(11-k1) including at least one of the packet parameters from the matching data base entry into the time synchronization packet, and
(11-k2) send the time synchronization packet on the egress port.

In an even further embodiment step (1-b3) may followed by the step of:
(12-11) sending the time synchronization command to the CPU via a separate interface,
(12-12) send the time synchronization command as a time synchronization packet to the CPU via the MAC,
(12-13) send the time synchronization command to one or more egress ports via an internal interface in the time synchronization module, or
(12-14) send the time synchronization command as a time synchronization packet to one or more egress ports via the MAC.

In an even further embodiment of the invention, the time synchronization command received on one or more egress ports is generated by the CPU and sent either:
(13-m1) as a time synchronization packet via the MAC, or
(13-m2) on a separate interface between the CPU and the time synchronization module.

In an even further embodiment of the invention (1-b3), the time synchronization command may be the:
(14-n1) same as the time synchronization packet received, or
(14-n2) same as the time synchronization packet received with at least one packet modification.

In an even further embodiment of the invention (1-c1), the time synchronization packet may be the:
(15-o1) same as the time synchronization command, or
(15-o2) same as the time synchronization command with at least one packet modification.

In an even further embodiment of the invention, the CPU sends and receives clock configuration parameters to the clock controller via:
(16-p1) a separate interface, or
(16-p2) the MAC as a packet.

In a second aspect the invention provides a method on a network element with one or more communication ports for transmitting and receiving data packets to and from other network elements in a network for the purpose of synchronization of clocks in a network, said network element comprising a time synchronization module comprising a time synchronization module clock and a database, said method comprising the following steps:
(17-q) receiving a time synchronization packet or a time synchronization command on a port of the time synchronization module of the network element, and
(17-r) if a time synchronization command is received on an egress controller of the time synchronization module, to perform the following steps:
(17-r1) generate a time synchronization packet according to the time synchronization command
(17-r2) generate an egress time stamp based on a time synchronization module clock, and
(17-r3) create a new data base entry and add the egress time stamp and at least one data base entry identifier into the new data base entry, or
(17-s) if a time synchronization packet is received on an ingress controller of the time synchronization module, to perform the following steps:
(17-s1) extract at least one data base entry identifier from the time synchronization packet for data base look-up, and
(17-s2) search for a data base entry match, wherein the entry contains a time stamp or a residence time.

In an embodiment step (17-r3) may be followed by the steps of:
(18) sending the time synchronization packet on an egress port.

In a further embodiment step (17-r3) may be followed by the steps of:
(19-t1) reading-out and including at least one general parameter from the data base into the time synchronization packet, and
(19-t2) send the time synchronization packet on an egress port.

In an even further embodiment step (17-s2) may be followed by the step of:
(20) if a data base entry match is found, to update the time synchronization packet with at least one identifier for the matching data base entry.

In an even further embodiment step (17-s2) may be followed by the step of:
(21) if a data base entry match is found, to update the time synchronization packet with a time stamp from the data base entry and send the time synchronization packet to the CPU.

In an even further embodiment step (17-s2) may be followed by the step of:
(22-u1) generate an ingress time stamp based on the time synchronization module clock, and
(22-u2) update the matching data base entry with a time stamp from the packet and the ingress time stamp.

In an even further embodiment step (17-s2) may be followed by the step of if a data base entry match is found, to:
(23-v1) generate an ingress time stamp based on the time synchronization module clock,
(23-v2) update the time synchronization packet with a time stamp from the matching data base entry and the ingress time stamp, and
(23-v3) send the time synchronization packet to the CPU.

In an even further embodiment the steps above (20 or 22-u2) may be followed by the steps of:
(24) generating a time synchronization command including at least one data base entry identifier from the matching data base entry.

In an even further embodiment the step (24) above may be followed by the steps of:
(25-w1) sending the time synchronization command to the CPU via a separate interface, or
(25-w2) send the time synchronization command as a packet to the CPU via the MAC.

In an even further embodiment the step (24) above, the time synchronization command is one of the following:
(26-x1) same as the time synchronization packet received, or
(26-x2) same as the time synchronization packet received with at least one packet modification.

In an embodiment step (17-r3), the time synchronization packet is:
(27) the time synchronization command.

In an even further embodiment step (17-s2) may be followed by the step of:
if a data base entry match with a residence time is found, to:
(28-y1) read-out the residence time from the data base entry,
(28-y2) update a time information in the received time synchronization packet with the residence time, and
(28-y3) send the received time synchronization packet to one or more egress ports or to the CPU via the MAC.
In a third aspect the invention provides a method on a network element with two or more communication ports for transmitting and receiving data packets to and from other network elements in a network for the purpose of synchronization of clocks in a network, said network element comprising a time synchronization module having a time synchronization module clock, said method comprising the following steps:
(29-z1) receiving a time synchronization packet on an ingress controller of the time synchronization module of the network element,
(29-z2) generating an ingress time stamp based on the time synchronization module clock,
(29-z3) inserting the ingress time stamp into the time synchronization packet,
(29-z4) sending the time synchronization packet to one or more egress ports,
(29-z5) receiving a time synchronization packet containing an ingress time stamp on an egress controller of the time synchronization module of the network element,
(29-z6) generating an egress time stamp based on the time synchronization module clock,
(29-z7) calculating a residence time and updating a time information of the time synchronization packet with the calculated residence time, and
(29-z8) sending the time synchronization packet on the egress port.

The present invention provides a solution where the accuracy of Transparent Clocks (only one control loop between the grand master and a slave) and the principles of having separate time synchronization properties similar to Boundary Clocks of each port of the network element can be combined.

IEEE1588 with 1-step clock support means that a time synchronization packet (SYNC event packet) contains the precise time egress time stamps. Reference [1] describes the general principles of a general Transparent Clock implementation with 1-step support. The present invention provides smart and cost-effective implementations of a 1-step Transparent Clock for IEEE 1588, NTP/SNTP or similar time synchronization protocols.

[1] J. Jasperneite, K. Shehab, K. Weber, “Enhancements to the time
synchronization performance of the network element.
Time Synchronization Standard IEEE-1588 for a System of Cascaded
Bridges,” in Proc. IEEE International Workshop on Factory
Communication Systems, September 2004, pp. 239-244.

One of the 1-step Transparent Clock implementation methods according an embodiments of the present invention and which are described in detail in the description below, is based on using a common data base for the ingress time stamps generated when time synchronization packets are received. That means SYNC and DELAY_REQ packets in case of IEEE 1588. These time stamps are read from the data base on the egress ports, residence times are calculated and inserted in the packets before the packets are sent to the media. The use of this data base is also relevant for Master Clock/time server, Slave Clock/client and 2-step Transparent Clock implementations. Also egress time stamps may be temporally stored in the data base for these clock modes. A data base entry is normally available for a new time stamp when the data base entry is read by the egress port(s) or the CPU. The data base depth should be designed so that a certain number of time synchronization packets can be temporarily queued in the switch of router without the risk for a data base entry overflow.

An alternative 1-step Transparent Clock implementation according to an embodiment of the present invention is also described. This solution is also based on insertion of time stamps on-the-fly into time synchronization packets on ingress ports, but not on egress. Instead the residence time is inserted on-the-fly on egress after the residence time is measured based on the ingress time found in the time synchronization packet and the estimated egress time for the packet.

Most implementations of time synchronization on network elements available today are based on pairing the time stamps and time synchronization packets in the CPU. The CPU performs all calculations based on the time stamps that are required for local clock control and for insertion of time stamps in the time synchronization packets sent by the network element. The present invention describes a method where the CPU need not take part in the insertion or updates of time stamps or residence times of time synchronization packets. An implementation of time synchronization in the CPU can then be made simple or may not be required at all. Reducing the need for a CPU to perform time synchronization has the benefit of handling higher time synchronization network load. Being able to handle a high time synchronization load is particularly important on network elements such as switches and routers as well as on time servers, where the time synchronization load can be vast.

The common data base for a time synchronization implementation based on the present invention on a switch or a router is accessible for all ports. Time information from an incoming time packet on a given ingress port in addition to a receive time stamp of the time synchronization packet can be written to the common data base and used by one or more egress ports when time synchronization packets are generated on these egress ports.

The present invention may be used for synchronization of end node clocks via a network, where the network elements perform time stamping of incoming and outgoing time packets in a time synchronization module close to the physical layer and where these time stamps are kept in a data base of the time synchronization module. The time synchronization module reduces or removes the time synchronization load on the CPU of the network element and therefore increases the time synchronization performance of the network element. The invention provides accuracy (same level of degradation) as a Transparent Clock and the same property as a Boundary Clock with respect to achieving good security properties on the network element since time sync packets are not sent from one port to another.

The present invention describes a method where time synchronization packets are not necessarily sent from ingress ports to egress ports, but instead time synchronization commands are sent from ingress to egress controller. Prohibiting time synchronization packets to be sent from ingress to egress ports has benefits with regards to security and routing. The solution introduces flexibility since encryption can be implemented on specific ports which are prone to attacks, for instance ports exposed to internet, while other ports can be left unencrypted. Different encryption algorithms for time synchronization packets can be implemented on each network port thereby increasing security. Providing time synchronization for several IP-domains, while still providing transparency support, is also possible since time synch commands rather than time synchronization packets are sent between ingress and egress ports.

The present invention also describes an alternative embodiment where the data base is not used. This method is relevant for 1-step Transparent Clocks. The ingress time stamp is inserted directly into in the time synchronization packet on the ingress port before the packet is sent to one or more egress ports in this embodiment of the invention. The residence time is calculated on an egress port based on the ingress time stamp found in the packet and the estimated egress time stamp on the egress controller of the time synchronization module before the packet is sent on the given egress port.

A switch or router time synchronization implementation according to this invention are provided in claims 1, 2, 3, 4, 28 and 29.

An IEEE1588 MC time synchronization implementation according to this invention are provided in claims 1, 5, 7 and 17.

An IEEE1588 SC time synchronization implementation according to this invention are provided in claims 1, 17, 20 and 21.

A NTP/SNTP server time synchronization implementation according to this invention are provided in claims 1 and 6.

A NTP/SNTP client time synchronization implementation according to this invention are provided in claims 17, 22 and 23.

### DESCRIPTION OF DRAWINGS

Embodiments of the invention will now be described with reference to the following drawings, in which:

FIGS. 1a, 1b and 1c shows an implementation of a Time Synchronization Module, TSM, as a separate module according to an embodiment of the present invention,

FIGS. 2a, 2b and 2c shows an implementation of a Time Synchronization Module, TSM, as part of a physical layer chip (PHY) (4), according to an embodiment of the present invention,

FIGS. 3a, 3b and 3c shows an implementation of a Time Synchronization Module, TSM, as part of the Media Access Controller (MAC) (6) according to an embodiment of the present invention,

FIGS. 4a and 4b shows an implementation of a Time Synchronization Module, TSM, as part of the MAC with integrated CPU (7) according to an embodiment of the present invention,

FIG. 4c shows an implementation of a Time Synchronization Module, TSM, as part of the MAC with integrated PHY and CPU (9) according to an embodiment of the present invention,

FIG. 5 shows main parts and interfaces of a Time Synchronization Module, TSM, according to an embodiment of the present invention, and

FIG. 6 shows main parts and interfaces of a Time Synchronization Module, TSM, according to a further embodiment of the present invention.

### DETAILED DESCRIPTION OF THE INVENTION

### Definitions

Update, shall be interpreted as modifying a time stamp or residence time by adding or subtracting to the said time stamp or residence time, when used in relation to time stamps or residence time.

Time information, can be ingress time stamps, egress time stamps, residence time, a time interval or system time depending on the definition in the subtext where it is used.

Recidence time, shall be interpreted as the time which a time synchronization packet resides in a switch, router, computer or other embedded network device. The residence time may also contain other time measures such as asymmetric delay or cable delays components.

Send packet, from the ICnt to the MAC or from the ECnt to the EPT shall in case the packet is modified be interpreted as containing a new MAC checksum. Other packet header parameters may also be modified if required. E.g. the UDP checksum must also be re-calculated or set to zero if this field originally was different from zero.

Include or insert a parameter in a packet or packet modification, shall be interpreted as either: 1) overwriting an existing field or part of such a field in the packet, or 2) generate a new field in the packet by extending the packet or inserting in front of the packet, or 3) in case the packet is sent from the ICnt to the MAC to use the packet buffer descriptor if such descriptor is available for both the ICnt and ECnt.

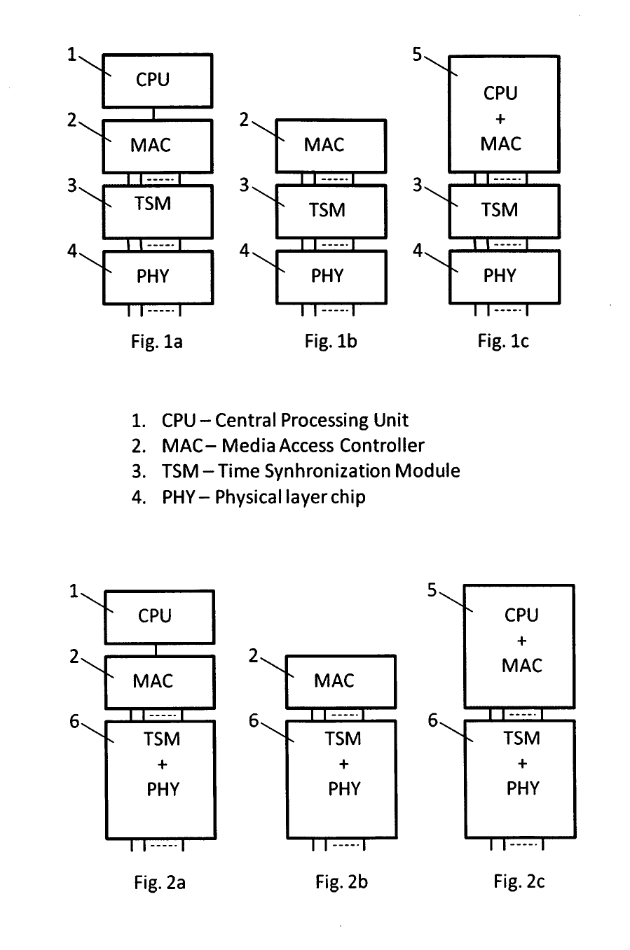

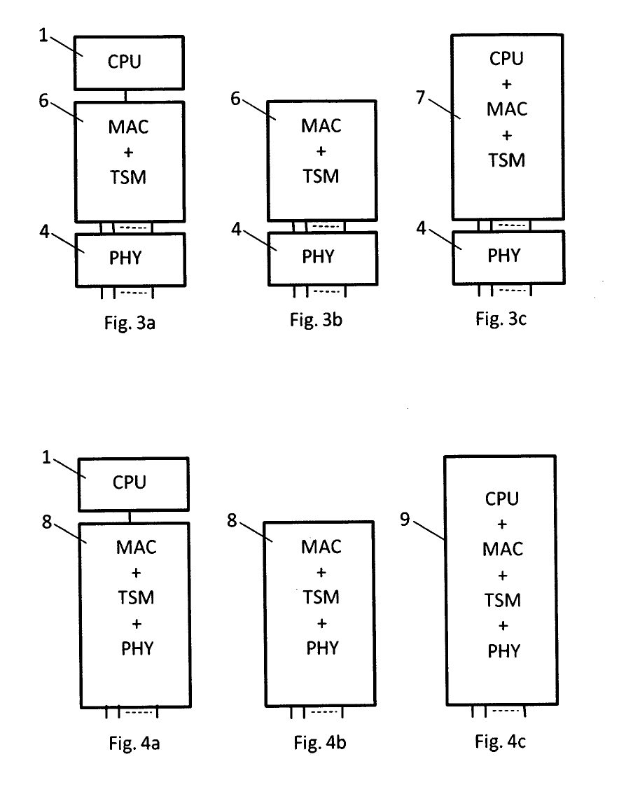

The present invention may be implemented in the form of a Time Synchronization Module, TSM. Several implementation alternatives of the Time Synchronization Module, TSM, are possible. The TSM can be implemented as:
a separate module as shown in FIGS. 1a, 1b and 1c
part of the physical layer chip (PHY) (4) as shown in FIGS. 2a, 2b and 2c
part of the Media Access Controller (MAC) (6), as shown in FIGS. 3a and 3b
part of the MAC with integrated CPU (7), as shown in FIG. 3c
part of the MAC with integrated PHY (8), as shown in FIGS. 4a and 4b
part of the MAC with integrated PHY and CPU (9), as shown in FIG. 4c

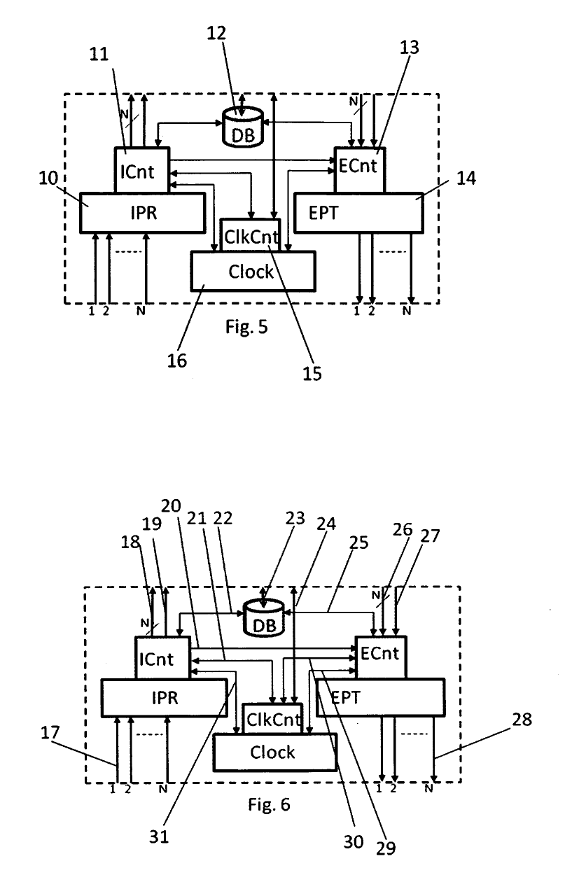

FIGS. 5 and 6 show the main parts and interfaces of an embodiment of the TSM. Incoming packets are received through the N ingress ports (17) at the Ingress Packet Receiver (IPR) (10). Packets from the Ingress Controller (ICnt) (11) are sent to the Media Access Controller (MAC) via an interface (18). The Ingress Controller ICnt generates an ingress time stamp by accessing the Clock (16) via the ingress clock interface (31) in case time synchronization packets are received. The ICnt then updates the Data Base DB, (12, 23) via the data base interface (22) with a new data base entry, containing parameters such as:
TSM parameters:
   Data base index
   Ingress time stamp
   Ingress port
Packet parameters
   MAC header information
   IP header information
   UDP header information
   Time synchronization payload information:
      Identifier of the time synchronization source
      Packet identifier (sequence number)
   Time synchronization quality parameters
      Time information from the time synchronization source including time stamps generated by the time source and residence time information from the time source and/or network elements between the time source and the network element that received the time synchronization packet

The data base entry index and/or a subset of the above parameters can be used as data base entry identifiers. The most relevant data base entry identifiers are considered to be:
Data base entry index
MAC source address
VLAN id
IP source address
Identifier of the time synchronization source

Packet identifier (sequence number) The ICnt can send Time Synchronization Commands (TSC) via three different interfaces:
A.) directly to one or more egress ports via the internal TSM interface (20)
B.) to the CPU or other TSM modules via a separate interface (19), or
C.) to the CPU or to one or more egress ports via the MAC (18) as a packet.

As a minimum, the TSC may contain data base entry identifier(s) and a MAC destination address that identifies the egress port(s) and/or the CPU. A more practical implementation may be based on a TSC content that is similar to the time synchronization packet that will sent on the egress port. This might be relevant in case a traditional Transparent Clock implementation is considered. That means that the synchronization packet that will be sent on one or more egress ports could be:
same as the TSC, or
same as the TSC with the data base entry index included, or
same as the TSC with the TSC type included, or
same as the TSC with the TSC type and data base entry index included,

The IPR and ICnt can be integrated in one part or the IPR may alternatively perform some of the ICnt functions such as generation of ingress time stamps by accessing the Clock from the IPR.

Packets from the MAC are received on an interface (26) on the Egress Controller (ECnt) (13). Packets that are not recognized as TSCs are sent to the Egress Packet Transmitter (EPT) (14) and sent on one of the N egress ports (28). The ECnt will perform data base look-up if a packet is recognized as a TSC. A TSC can be received from the ICnt or the CPU via the MAC interface (26), from the CPU via the separate CPU interface (27) or directly from the ICnt via the internal TSM interface (20).

Data base look-up can also be for performed for the purpose of reading out general parameters that are common for all time synchronization packets originating from a given egress port on the TSM. Such general parameters can be:
Static parameters such as:
   Clock identity of the network element
   MAC address of the network element or the TSM/egress port
   Clock type
Variable parameters such as:
   Clock quality of the network element
   IP address of the network element or TSM/egress port

The Egress Controller ECnt may perform either of the following functions depending on the TSC type if a TSC is received:
TSC_A:
perform a data base look-up via the data base interface (25) based on the data base entry identifier(s) found in the TSC,
   read-out the ingress time stamp and other parameters if a data base entry match with an ingress time stamp is found,
   generate an egress time stamp via the Clock interface (29), and calculate the residence time (egress time stamp−ingress time stamp),
   generate a time synchronization packet (A) with the calculated residence time, packet parameters from the data base or the time synchronization command or general parameters from the data base, and
   send the new packet to the EPT that sends the packet to one of the N egress ports (28).
This command is relevant when sending a time synchronization packet such as an IEEE1588 SYNC 1-step or an IEEE1588 DELAY_REQUEST packet from a switch or router.
TSC_B:
   perform a data base look-up via the data base interface based on the data base entry identifier(s) found in the TSC,
   read-out the ingress time stamp and other parameters if a data base entry match is found,
   generate an egress time stamp via the Clock interface, and calculate the residence time (egress time stamp−ingress time stamp),
   update the data base entry or create an new data base entry with the calculated residence time,
   New TSM parameters:
      i. Data base index
      ii. Residence time
      iii. Egress port,
   generate a time synchronization packet (B) with packet parameters from the data base or the time synchronization command or general parameters from the data base, and
   send the new packet to the EPT that sends the packet to one of the N egress ports.
This command is relevant when sending a time synchronization packet such as an IEEE1588 SYNC 2-step packet from a switch or router.
TSC_C:
   perform a data base look-up via the data base interface based on the data base entry identifier(s) found in the TSC,
   read-out the residence time stamp and other parameters if a data base entry match is found,
   generate a time synchronization packet (C) with the calculated residence time, packet parameters from the data base or the time synchronization command or general parameters from the data base, and
   send the new packet to the EPT that sends the packet to one of the N egress ports.
   This command is relevant when sending a time synchronization packet such as an IEEE1588 FOLLOW-UP or DELAY_RESPONSE packet from a switch or router.
TSC_D:
   perform a data base look-up via the data base interface based on the data base entry identifier(s) found in the TSC (e.g. the egress port should be the same as the ingress port where the ingress time stamp was generated),
   read-out the ingress time stamp and other parameters if a data base entry match is found,
   generate a time synchronization packet (D) with the ingress time stamp, packet parameters from the data base or the time synchronization command or general parameters from the data base, and
   send the new packet to the EPT that sends the packet to one of the N egress ports.
This command is relevant when sending a time synchronization packet such as an IEEE1588 DELAY_RESPONSE packet from a MC.
TSC_E:
   perform a data base look-up via the data base interface based on the data base entry identifier(s) found in the TSC (e.g. the egress port should be the same as the ingress port where the ingress time stamp was generated),
   read-out the ingress time stamp and other parameters if a data base entry match is found,
   generate an egress time stamp via the Clock interface,
   generate a time synchronization packet (E) with the ingress- and egress time stamp, packet parameters from the data base or the time synchronization command or general parameters from the data base, and
   send the new packet to the EPT that sends the packet to one of the N egress ports.
This command is relevant when sending a time synchronization packet such as a SNTP/NTP REPLAY packet from a SNTP/NTP server.
TSC_F:
   perform a data base look-up via the data base interface based on the data base entry identifier(s) found in the TSC,
   generate an egress time stamp via the Clock interface,
   create a new data base entry with the egress time stamp and data base entry identifier(s) from the TSC,
   New TSM parameters:
      i. Data base index
      ii. Egress time
      iii. Egress port,
   generate a time synchronization packet (F) with packet parameters from the data base or the time synchronization command or general parameters from the data base, and
   send the time synchronization packet (F) to the EPT that sends the packet to one of the N egress ports.
This command is relevant when sending a time synchronization packet such as an IEEE1588 SYNC 2-step packet from a MC, an IEEE1588 DELAY_REQUEST packet from a SC or a SNTP/NTP REQUEST packet from a SNTP/NTP client.
TSC_G:
   perform a data base look-up via the data base interface based on the data base entry identifier(s) found in the TSC (e.g. the egress port should be the same as the egress port where the egress time stamp was generated when the TSC_F command was performed),
   read-out the egress time stamp and other parameters if a data base entry match is found,
   generate a time synchronization packet (G) with the egress time stamp, packet parameters from the data base or the time synchronization command or general parameters from the data base, and
   send the time synchronization packet (G) to the EPT that sends the packet to one of the N egress ports.
This command is relevant when sending a time synchronization packet such as an IEEE1588 FOLLOW-UP packet from a MC.
TSC_FG:
   This command instructs the TSM to perform both a TSC_F and a TSC_G command.
TSC_FG2:
   Same as TSC_FG, but where the TSM is instructed to perform the TSC_F and TSC_G commands multiple number of times (M) with a specified time interval in-between the TSC_FG's. M=0 means that the TSC_FG's shall be performed continuously (infinite number of times)
TSC_H:
   perform a data base look-up via the data base interface based on the data base entry identifier(s) found in the TSC,
   generate an egress time stamp via the Clock interface,
   generate a time synchronization packet (H) with the egress time stamp, packet parameters from the data base or the time synchronization command or general parameters from the data base, and
   send the time synchronization packet (H) to the EPT that sends the packet to one of the N egress ports.
This command is relevant when sending a time synchronization packet such as an IEEE1588 SYNC 1-step packet from a MC.
TSC_H2:
   Same as TSC_H, but where the TSM is instructed to perform the TSC_H command multiple number of times (M) with a specified time interval in-between the TSC_H's. M=0 means that the TSC_H's shall be performed continuously (infinite number of times).

If the TSC is sent via the internal interface to the ECnt, then the ICnt can send a dummy packet to the egress port(s) in order to avoid packet buffering on the egress ports(s). The ECnt can then send the new time synchronization packet to the EPT during the time the time synchronization packet would have been sent if this time synchronization packet was handled as any other packet.

The EPT and ECnt can be integrated in one part, or the EPT may alternatively perform some of the ECnt functions such as generation of egress time stamps by accessing the Clock from the EPT.

The ICnt may adjust the Clock via the Clock Controller (ClkCnt) (15) through interface (21) for offset and drift based on time update information from ingress time synchronization packets, and/or data base look up of egress time stamps generated based on the TSC_F command.

Clock offset and drift correction can also be performed by the CPU via a separate interface (24). The CPU can for this purpose read-out relevant ingress- and egress time stamps from a separate data base interface (23). The CPU may also send parameters for clock adjustment as standard packets to the ECnt. These packets will not be sent to the EPT. The ECnt can adjust the clock via the interface (30) to the clock controller of the TSM.

The TSM can send special time synchronization commands containing time synchronization statistics related to the TSM operation to the CPU. That means:
Type and number of time synchronization packets received per ingress port
Type and number of time synchronization packets transmitted per ingress port
Faulty time sync packets received per ingress port
Clock quality

This can be done on regular basis or on events (e.g. on errors) via a separate interface to the CPU (19) or as packets sent via the MAC to the CPU.

A network element with two or more ports (e.g. switch or router) with 1-step Transparent Clock support can be based on a principle that does not include a data base. The ingress time stamp generated when a synchronization packet is handled in the ICnt can be inserted directly into the synchronization packet (i.e. SYNC or DELAY_REQ packets in case IEEE 1588 is used as the time synchronization protocol). This ingress time stamp is extracted by the ECnt when the packet is received from the MAC, an egress time stamp is generated by accessing the TSM clock, the residence time is calculated based on the two time stamps and the packet is updated with this residence time before the packet is sent to the EPT.

Having described preferred embodiments of the invention it will be apparent to those skilled in the art that other embodiments incorporating the concepts may be used. These and other examples of the invention illustrated above are intended by way of example only and the actual scope of the invention is to be determined from the following claims.

1. Method on a network element with one or more communication ports for transmitting and receiving data packets to and from other network elements in a network for the purpose of synchronization of clocks in a network, said network element comprising a time synchronization module, a time synchronization module clock and a database, said method comprising the following steps:
(a) receiving a time synchronization packet or a time synchronization command on a port of the time synchronization module of the network element, and
(b) if a time synchronization packet is received on an ingress controller of the time synchronization module, to perform the following steps:
(b1) generate an ingress time stamp based on the time synchronization module clock,
(b2) create a new entry in the data base of the time synchronization module and add the ingress time stamp and at least one data base entry identifier into the new data base entry, and
(b3) generate a time synchronization command including at least one data base entry identifier, or
(c) if a time synchronization command is received on an egress controller of the time synchronization module, to perform the following steps:
(c1) generate a time synchronization packet according to the time synchronization command,
(c2) extract at least one data base entry identifier from the time synchronization command for data base look-up, and
(c3) search for a data base entry match, wherein the entry contains an ingress time stamp, an egress time stamp, a residence time or a combination of these.

2. Method according to claim 1, wherein said step (c3) is followed by the steps of:
if a data base entry match with an ingress time stamp is found, to:
(d1) generate an egress time stamp based on the time synchronization module clock,
(d2) read-out the ingress time stamp from the data base entry,
(d3) calculate the residence time, and
(d4) update a time information of the time synchronization packet with the calculated residence time.

3. Method according to claim 1, wherein said step (c3) is followed by the steps of:
if a data base entry match with an ingress time stamp is found, to:
(e1) generate an egress time stamp based on the time synchronization module clock,
(e2) read-out the ingress time stamp from the data base entry,
(e3) calculate the residence time, and
(e4) update the data base with the calculated residence time and the egress port.

4. Method according to claim 1, wherein said step (c3) is followed by the step of:
if a data base entry match with a residence time and an egress port is found and the egress port of the data base entry is the same as the egress port where the time synchronization command is received, to:
(f1) read-out the residence time from the data base, and
(f2) update a time information of the time synchronization packet with the residence time.

5. Method according to claim 1, wherein said step (c3) is followed by the step of:
if a data base entry match with an ingress time stamp is found, to:
(g1) read-out the ingress time stamp from the data base, and
(g2) include the ingress time stamp in the time synchronization packet.

6. Method according to claim 1, wherein said step (c3) is followed by the step of:
(h1) generate an egress time stamp based on the time synchronization module clock, and
if a data base entry match with an ingress time stamp is found, to:
(h2) read-out the ingress time stamp from the data base, and
(h3) include the egress time stamp and the ingress time stamp in the time synchronization packet.

7. Method according to claim 1, wherein said step (c3) is followed by the step of:
if a data base entry match with an egress time stamp is found, to:
(i1) read-out the egress time stamp from the data base, and
(i2) include the egress time stamp in the time synchronization packet.

8. Method according to claim 2, followed by the step of:
sending the time synchronization packet on an egress port.

9. Method according to claim 2, followed by the step of:
(j1) reading-out and include at least one general parameter from the data base into the time synchronization packet, and
(j2) send the time synchronization packet on an egress port.

10. Method according to claim 1, wherein said step (b2) is followed by the steps of:
adding at least one packet parameter from the time synchronization packet into the new data base entry.

11. Method according to claim 2, followed by the steps of:
(k1) including at least one of the packet parameters from the matching data base entry into the time synchronization packet, and
(k2) send the time synchronization packet on the egress port.

12. Method according to claim 1 wherein said step (b3) is followed by one of the following steps of:
(l1) sending the time synchronization command to the CPU via a separate interface,
(l2) send the time synchronization command as a time synchronization packet to the CPU via the MAC,
(3) send the time synchronization command to one or more egress ports via an internal interface in the time synchronization module, or
(l4) send the time synchronization command as a time synchronization packet to one or more egress ports via the MAC.

13. Method according to claim 1, where the time synchronization command received on one or more egress ports is generated by the CPU and sent either:
(m1) as a time synchronization packet via the MAC, or
(m2) on a separate interface between the CPU and the time synchronization module.

14. Method according to claim 1 (b3), where the time synchronization command is one of the following:
(n1) same as the time synchronization packet received, or
(n2) same as the time synchronization packet received with at least one packet modification.

15. Method according to claim 1 (c1), where the time synchronization packet is one of the following:
(o1) same as the time synchronization command, or
(o2) same as the time synchronization command with at least one packet modification.

16. Method according to claim 1, where the CPU sends and receives clock configuration parameters to the clock controller via:
(p1) a separate interface, or
(p2) the MAC as a packet.

17. Method on a network element with one or more communication ports for transmitting and receiving data packets to and from other network elements in a network for the purpose of synchronization of clocks in a network, said network element comprising a time synchronization module comprising a time synchronization module clock and a database, said method comprising the following steps:
(q) receiving a time synchronization packet or a time synchronization command on a port of the time synchronization module of the network element, and
(r) if a time synchronization command is received on an egress controller of the time synchronization module, to perform the following steps:
(r1) generate a time synchronization packet according to the time synchronization command,
(r2) generate an egress time stamp based on a time synchronization module clock, and
(r3) create a new data base entry and add the egress time stamp and at least one data base entry identifier into the new data base entry, or
(s) if a time synchronization packet is received on an ingress controller of the time synchronization module, to perform the following steps:
(s1) extract at least one data base entry identifier from the time synchronization packet for data base look-up, and
(s2) search for a data base entry match, wherein the entry contains a time stamp or a residence time.

18. Method according to claim 17 (r3) followed by the step of:
sending the time synchronization packet on an egress port.

19. Method according to claim 17 (r3) followed by the step of:
(t1) reading-out and including at least one general parameter from the data base into the time synchronization packet, and
(t2) send the time synchronization packet on an egress port.

20. Method according to claim 17 wherein said step (s2) is followed by the step of:
if a data base entry match is found, to update the time synchronization packet with at least one identifier for the matching data base entry.

21. Method according to claim 17 wherein said step (s2) is followed by the step of:
if a data base entry match is found, to update the time synchronization packet with a time stamp from the data base entry and send the time synchronization packet to the CPU.

22. Method according to claim 17 wherein said step (s2) is followed by the step of:
if a data base entry match is found, to:
(u1) generate an ingress time stamp based on the time synchronization module clock, and
(u2) update the matching data base entry with a time stamp from the packet and the ingress time stamp.

23. Method according to claim 17 wherein said step (s2) is followed by the step of:
if a data base entry match is found, to:
(v1) generate an ingress time stamp based on the time synchronization module clock,
(v2) update the time synchronization packet with a time stamp from the matching data base entry and the ingress time stamp, and
(v3) send the time synchronization packet to the CPU.

24. Method according to claim 20, where the said steps are followed by the steps of:
generating a time synchronization command including at least one data base entry identifier from the matching data base entry.

25. Method according to claim 24 wherein said step is followed by the step of either:
(w1) sending the time synchronization command to the CPU via a separate interface, or
(w2) send the time synchronization command as a packet to the CPU via the MAC.

26. Method according to claim 24, where the time synchronization command is one of the following:
(x1) same as the time synchronization packet received, or
(x2) same as the time synchronization packet received with at least one packet modification

27. Method according to claim 17 (r3), where the time synchronization packet is the time synchronization command.

28. Method according to claim 17 wherein said step (s2) is followed by the step of:
if a data base entry match with a residence time is found, to:
(y1) read-out the residence time from the data base entry,
(y2) update a time information in the received time synchronization packet with the residence time, and
(y3) send the received time synchronization packet to one or more egress ports or to the CPU via the MAC.

29. Method on a network element with two or more communication ports for transmitting and receiving data packets to and from other network elements in a network for the purpose of synchronization of clocks in a network, said network element comprising a time synchronization module having a time synchronization module clock, said method comprising the following steps:
(z1) receiving a time synchronization packet on an ingress controller of the time synchronization module of the network element,
(z2) generating an ingress time stamp based on the time synchronization module clock,
(z3) inserting the ingress time stamp into the time synchronization packet,
(z4) sending the time synchronization packet to one or more egress ports,
(z5) receiving a time synchronization packet containing an ingress time stamp on an egress controller of the time synchronization module of the network element,
(z6) generating an egress time stamp based on the time synchronization module clock,
(z7) calculating a residence time and updating a time information of the time synchronization packet with the calculated residence time, and
(z8) sending the time synchronization packet on the egress port.
